(19) United States
(12) Patent Application Publication
(10) Pub. No.: US 2025/0271800 A1
(43) Pub. Date: Aug. 28, 2025

(54) IMAGE FORMING DEVICE, IMAGE FORMING METHOD, AND NON-TRANSITORY COMPUTER-READABLE RECORDING MEDIUM

(71) Applicant: SHARP KABUSHIKI KAISHA, Osaka (JP)

(72) Inventors: TAKASHI USUI, Osaka (JP); Shota Kaneko, Osaka (JP); Taketo Nozaki, Osaka (JP)

(21) Appl. No.: 19/058,344

(22) Filed: Feb. 20, 2025

(30) Foreign Application Priority Data
Feb. 22, 2024 (JP) 2024-025040
Dec. 26, 2024 (JP) 2024-229638

(51) Int. Cl. G03G 15/00; G03G 15/01

(52) U.S. Cl. CPC G03G 15/5041; G03G 15/0105; G03G 2215/00063

(57) ABSTRACT

An image forming device includes a controller, an image former that causes a color material to adhere to a sheet for each of multiple pixels arranged in a first direction, and a sheet feeder that feeds the sheet in a second direction. The controller determines whether a first color material used for a first pixel out of the multiple pixels is identical to a second color material used for a second pixel adjacent to the first pixel on a training end side in the second direction with respect to the first pixel, and executes a correction process of correcting a density of the first color material when it is determined that the first color material is identical to the second color material, the density of the first color material is lower than a first density, and a density of the second color material is equal to or higher than a second density that is equal to or higher than the first density.

### CROSS-REFERENCE TO RELATED APPLICATION

The present application claims priority from Japanese Application JP2024-025040, filed on Feb. 22, 2024, and Japanese Application JP2024-229638, filed on Dec. 26, 2024, the content of which is hereby incorporated by reference into this application.

### BACKGROUND

### 1. Field

The disclosure relates to an image forming device, an image forming method, and a non-transitory computer-readable recording medium.

### 2. Description of the Related Art

In the related art, an image forming device capable of outputting print data while making a change in a drawing condition for ruled lines included in the print data based on an operation by a user.

### SUMMARY

Characters or ruled lines on a colored background may appear thicker than the characters or the ruled lines on an uncolored region. In the image forming device disclosed in Patent Document 1, it is not possible to specify characters and ruled lines on a colored background to adjust the thicknesses of the characters and the ruled lines. In the image forming device disclosed in the related art, there is a concern that characters or ruled lines on a colored background may appear thicker than the characters or the ruled lines on a non-colored region even when output is executed with a drawing condition for ruled lines changed. Therefore, an object of one aspect of the disclosure is to provide an image forming device, an image forming method, and a non-transitory computer-readable recording medium capable of suppressing a phenomenon in which characters and ruled lines on a colored background appear thicker than the characters and the ruled lines on a non-colored region.

An image forming device according to an embodiment of the disclosure includes a controller, an image former that causes a color material to adhere to a sheet for each of multiple pixels arranged in a first direction, and a sheet feeder that feeds the sheet in a second direction. The controller determines whether a first color material used for a first pixel out of the multiple pixels is identical to a second color material used for a second pixel adjacent to the first pixel on a trailing end side in a second direction with respect to the first pixel, and executes a correction process of correcting a density of the first color material when it is determined that the first color material is identical to the second color material, the density of the first color material is lower than a first density, and a density of the second color material is equal to or higher than a second density that is equal to or higher than the first density.

An image forming method according to an embodiment of the disclosure is an image forming method executed by one or more processors, the image forming method including: determining whether a first color material used for a first pixel out of multiple pixels arranged in a first direction is identical to a second color material used for a second pixel on a trailing end side in a second direction with respect to the first pixel; executing a correction process of correcting a density of the first color material when it is determined that the first color material is identical to the second color material, the density of the first color material is lower than a first density, and a density of the second color material is equal to or higher than a second density that is equal to or higher than the first density; causing a color material to adhere to a sheet for each of the multiple pixels arranged along the first direction; and feeding the sheet to the second direction.

A non-transitory computer-readable recording medium according to an embodiment of the disclosure stores a program for a computer, the computer controlling an image forming device including an image former that causes a color material to adhere to a sheet for each of multiple pixels arranged in a first direction and a sheet feeder that feeds the sheet in a second direction, the program causing the computer to: determine whether a first color material used for a first pixel out of the multiple pixels is identical to a second color material used for a second pixel on a trailing end side in a second direction with respect to the first pixel; and execute a correction process of correcting a density of the first color material when it is determined that the first color material is identical to the second color material, the density of the first color material is lower than a first density, and a density of the second color material is equal to or higher than a second density that is equal to or higher than the first density.

### BRIEF DESCRIPTION OF THE DRAWINGS

FIG. 1 is a block diagram illustrating an example of a configuration of an image forming device.

FIG. 2 is a diagram for explaining an operation of an image former.

FIG. 3 is a diagram illustrating an example of positions of a first pixel, a second pixel, a first region, and a second region.

FIG. 4 is a flowchart illustrating an example of an operation of an image forming device according to a first embodiment.

FIG. 5A is a diagram illustrating an example of a region including a linear object and a background of the linear object.

FIG. 5B is a diagram illustrating an example of the densities of color materials used for pixels in the region illustrated in FIG. 5A.

FIG. 6A is a diagram illustrating an example of a region including a linear object and a background of the linear object.

FIG. 6B is a graph showing an example of the densities of color materials after correction for pixels in the region illustrated in FIG. 6A.

FIG. 6C is a diagram illustrating an example of an image after the correction illustrated in FIG. 6B.

FIG. 6D is a graph showing an example of the densities of color materials after correction for pixels in the region illustrated in FIG. 6A.

FIG. 6E is a diagram illustrating an example of an image after the correction illustrated in FIG. 6D.

FIG. 7 is a flowchart illustrating an example of an operation of an image forming device according to a third embodiment.

FIG. 8 is a diagram illustrating an example of a case where the color material used for a first pixel is one color and the density of the color material is reduced for multiple pixels included in a first region.

FIG. 9 is a diagram illustrating an example of a case where the color material used for a first pixel is not one color and the density of the color material is reduced for multiple pixels included in a first region.

FIG. 10 is a flowchart illustrating an example of an operation of an image forming device according to a fourth embodiment.

FIG. 11 is a diagram illustrating an example of processing of step S1008 illustrated in FIG. 10.

FIG. 12 is a diagram illustrating an example of a first density and a second density.

### DETAILED DESCRIPTION OF THE DISCLOSURE

### First Embodiment

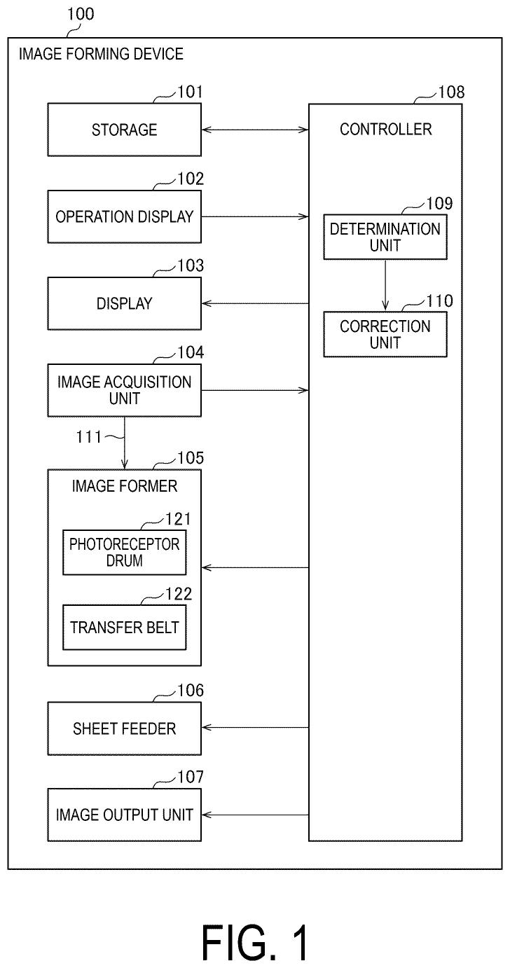

The first embodiment will be described with reference to FIGS. 1 to 5B. In the drawings, the same or equivalent elements are denoted by the same reference signs, and redundant descriptions will be omitted.

Image data 111 used in an image forming device 100 corresponds to a color image using the colors of black (K), cyan (C), magenta (M), and yellow (Y).

The image data 111 indicates pixel value information. The pixel value information indicates a coordinate value and a pixel value of each of multiple pixels indicated by the image data 111.

FIG. 1 is a block diagram illustrating an example of a configuration of the image forming device 100. The image forming device 100 includes a storage 101, an operation unit 102, a display 103, an image acquisition unit 104, an image former 105, a sheet feeder 106, an image output unit 107, and a controller 108.

The storage 101 is a recording medium capable of recording various types of data, programs, and the like. For example, the storage 101 includes one or more hard disk drives (HDD), one or more solid state drives (SSD), one or more semiconductor memories, or the like.

The operation unit 102 receives an operation by a user. For example, the operation unit 102 receives an operation of selecting a function implemented in the image forming device 100 and an operation of designating the number of sheets to be printed. The operation unit 102 includes a touch panel, a mouse, a keyboard, or the like.

The display 103 displays information presented to the user. For example, the display 103 includes a liquid crystal panel, an organic electro-luminescence (EL) panel, or the like.

The image acquisition unit 104 acquires the image data 111. For example, the image acquisition unit 104 reads a document placed on a document table (not illustrated) and acquires the image data 111 indicating the read document. Alternatively, the image acquisition unit 104 acquires the image data 111 by receiving the image data 111 transmitted from a terminal device (not illustrated) connected to the image forming device 100 via a network. For example, the terminal device is a personal computer (PC), a smartphone, a tablet terminal, or the like.

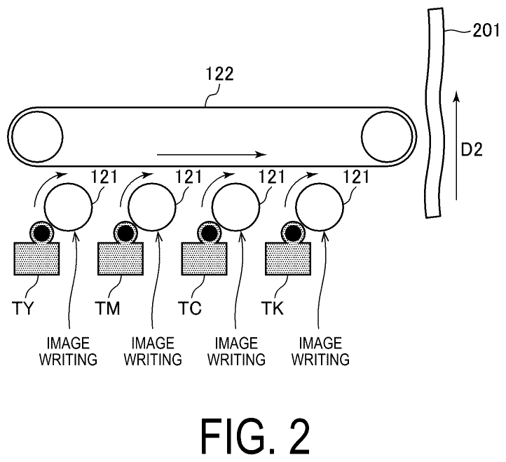

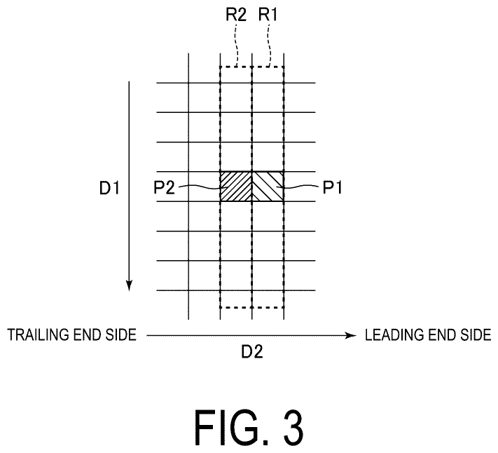

The image former 105 forms an image based on the image data 111 by causing a color material to adhere to a sheet 201 (see FIG. 2) in a first direction D1 (see FIG. 3). For example, the image former 105 is configured with a laser printer using an electrophotographic system, and forms an image on the sheet 201 by causing toner as a color material to adhere to the sheet 201.

The image former 105 includes photoreceptor drums 121, a transfer belt 122, and the like.

The image former 105 exposes the photoreceptor drums 121, which are electrically charged, in accordance with the image data 111 to form electrostatic latent images in accordance with the image data 111 on the surfaces of the photoreceptor drums 121. The image former 105 visualizes the electrostatic latent images formed on the respective photoreceptor drums 121 with four color (KCMY) toners TK (see FIG. 2), TC (see FIG. 2), TM (see FIG. 2), and TY (see FIG. 2).

Four photoreceptor drums 121 are provided and set to black, cyan, magenta, and yellow, respectively, so as to form four types of latent images corresponding to the respective colors, and constitute four image stations.

Toner images of the respective colors visualized by the toner adhering to the electrostatic latent images formed on the respective photoreceptor drums 121 are stacked on the transfer belt 122. The stacked toner images are transferred onto the sheet 201 by rotation of the transfer belt 122.

The sheet feeder 106 feeds the sheet 201 on which the image based on the image data 111 is formed by the image former 105, in a second direction D2 (see FIGS. 2 and 3). The sheet feeder 106 includes a roller and/or a belt for feeding the sheet 201.

The image output unit 107 outputs the sheet 201 on which the image based on the image data 111 is formed by the image former 105 from a sheet discharge port (not illustrated).

The controller 108 controls the entirety of the image forming device 100. The controller 108 realizes various functions by reading and executing various programs stored in the storage 101. The controller 108 may be implemented by one or multiple control devices/arithmetic devices (such as a Central Processing Unit (CPU), a System on a Chip (SoC)), one or multiple RAMs (random access memories), one or multiple ROMs (read only memories), various interface circuits, or the like. Further, some or all of the processors included in the controller 108 may be constituted by an electronic circuit. The controller 108 includes a determination unit 109 and a correction unit 110. The determination unit 109 and the correction unit 110 are realized by the controller 108 reading and executing various programs stored in the storage 101.

The determination unit 109 determines whether a first color material used for a first pixel P1 (see FIG. 3) indicated by the image data 111 is the same as a second color material used for a second pixel P2 (see FIG. 3) adjacent to the first pixel P1 on the trailing end side in the second direction D2. The first color material and the second color material being the same means that the combination of color components used in the first pixel P1 and the combination of color components used in the second pixel P2 are the same.

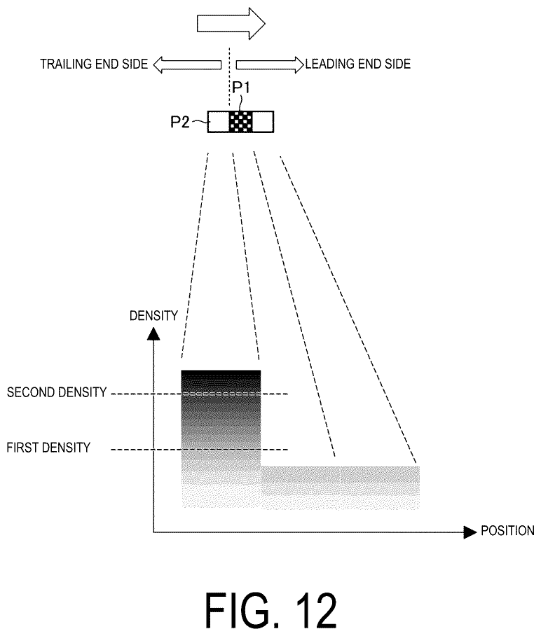

The correction unit 110 executes a correction process when it is determined that the first color material and the second color material are the same, the density of the first color material is lower than a first density (see FIG. 12), and the density of the second color material is equal to or higher than a second density (see FIG. 12) which is equal to or higher than the first density. The first density and the second density are predetermined densities. For example, the difference between the first density and the second density is greater than a predetermined density difference. Further, for example, it is assumed that the first density and the second density are maximum densities. In this case, when the determination unit 109 determines that the first color material and the second color material are the same, the first color material does not have the maximum density, and the second color material has the maximum density, the correction unit 110 executes a correction process of correcting the density of the first color material. Specifically, the correction unit 110 executes a process of reducing the density of the first color material as the correction process.

FIG. 2 is a diagram for explaining an operation of the image former 105.

The transfer belt 122 is provided so as to be in contact with each of the photoreceptor drums 121. As the transfer belt 122 rotates, the toner images of the respective colors K, C, M, and Y formed on the photoreceptor drums 121 are sequentially transferred to the transfer belt 122 in a superimposed manner. Thus, a color toner image is formed on the transfer belt 122. The toner image is transferred onto the sheet 201 by the rotation of the transfer belt 122. Accordingly, the image former 105 causes the color material to adhere to the sheet 201 for each of the multiple pixels arranged in the first direction D1 (see FIG. 3). Then, the sheet feeder 106 feeds the sheet 201 in the second direction D2, and the image former 105 forms a new toner image on the transfer belt 122. Then, the new toner image is transferred onto the sheet 201 along the first direction D1 by the rotation of the transfer belt 122.

FIG. 3 is a diagram illustrating an example of positions of the first pixel P1, the second pixel P2, a first region R1, and a second region R2. The second pixel P2 is adjacent to the first pixel P1. The second region R2 is a linear region that includes the second pixel P2 and extends in the first direction D1. The first region R1 is a region that includes the first pixel P1 and is adjacent to the second region R2. Although one first pixel P1 and one second pixel P2 are illustrated in FIG. 3, the first pixel P1 may be adjacent to each of multiple second pixels P2 included in the second region R2. That is, when the multiple second pixels P2 are arranged in the first direction D1, multiple first pixels PI may be arranged along the multiple second pixels P2.

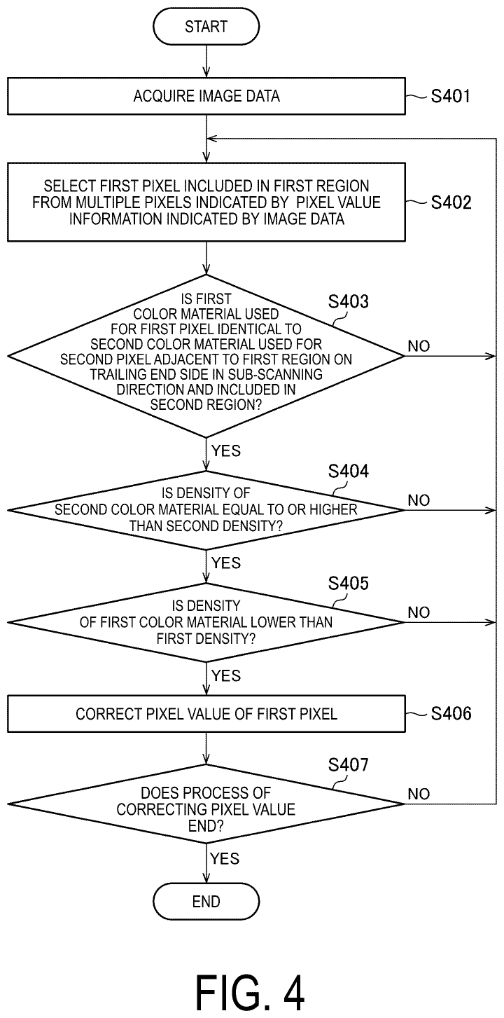

FIG. 4 is a flowchart illustrating an example of an operation of the image forming device 100 according to the present embodiment.

In step S401, the image acquisition unit 104 acquires the image data 111.

In step S402, the determination unit 109 selects the first pixel P1 included in the first region R1 from multiple pixels indicated by pixel value information indicated by the acquired image data 111. For example, the determination unit 109 sequentially scans the multiple pixels indicated by the pixel value information indicated by the image data 111 and sequentially selects the first pixel P1 from the multiple pixels. Alternatively, for example, the determination unit 109 determines a linear object along the first direction D1 from the image based on the image data 111. For example, the linear object is a character or a ruled line. Then, the determination unit 109 selects the first pixel P1 from the multiple pixels included in the first region R1 adjacent in the second direction D2 to the second region R2 indicating the determined linear object.

In step S403, the determination unit 109 determines whether a first color material used for the selected first pixel P1 is the same as a second color material used for the second pixel P2 included in the second region R2.

Specifically, the determination unit 109 determines whether the combination of color components used for the first pixel P1 is the same as the combination of color components used for the second pixel P2.

For example, it is assumed that a color component of black (K) is used as the first color material, and color components of cyan (C), magenta (M), and yellow (Y) are not used. In addition, it is assumed that a color component of black (K) is used as the second color material, and color components of cyan (C), magenta (M), and yellow (Y) are not used. In this case, the determination unit 109 determines that the first color material and the second color material are the same.

In addition, for example, it is assumed that a color component of black (K) is used as the first color material, and color components of cyan (C), magenta (M), and yellow (Y) are not used. On the other hand, it is assumed that color components of black (K) and cyan (C) are used as the second color material, and color components of magenta (M) and yellow (Y) are not used. In this case, the determination unit 109 determines that the first color material and the second color material are not the same.

When the first color material and the second color material are not the same in step S403, the controller 108 returns the processing to step S402. That is, the determination unit 109 selects a new first pixel P1 and continues the processing.

On the other hand, when the first color material and the second color material are the same in step S403, the determination unit 109 determines in step S404 whether the density of the second color material is equal to or higher than the second density. The second density is a predetermined density. For example, the second density is determined in accordance with the specification of the image former 105. Specifically, the second density is determined in accordance with the correction amount of the surface potential of the photoreceptor drums 121, the correction amount of the voltage value in a process of visualizing electrostatic latent images formed on the photoreceptor drums 121, the current value in a process of transferring the visualized toner image of each color onto the transfer belt 122, and the like. Alternatively, the controller 108 may determine the second density in accordance with the distribution of multiple pixel values included in an image based on the image data 111. For example, it is assumed that the second density is the maximum density. In this case, in step S404, the determination unit 109 determines whether the density of the second color material is the maximum density. Specifically, when the densities of all the color components used in the second color material are the maximum densities, the determination unit 109 determines that the density of the second color material is the maximum density.

For example, when the density of black (K) is 100%, the density of cyan (C) is 0%, the density of magenta (M) is 0%, and the density of yellow (Y) is 0% among the multiple color components in the second color material, it is determined that the density of the second color material is the maximum density. Alternatively, for example, when the density of black (K) is 100%, the density of cyan (C) is 100%, the density of magenta (M) is 0%, and the density of yellow (Y) is 0% among the multiple color components in the second color material, it is determined that the density of the second color material is the maximum density.

When the density of the second color material is not equal to or higher than the second density in step S404, the controller 108 returns the processing to step S402. For example, it is assumed that the second density is the maximum density. In this case, when the density of the second color material is not the maximum density in step S404, the controller 108 returns the processing to step S402. That is, the determination unit 109 selects a new first pixel P1 and continues the processing.

On the other hand, when the density of the second color material is equal to or higher than the second density in step S404, the determination unit 109 determines in step S405 whether the density of the first color material is lower than the first density. The first density is a predetermined density. For example, the first density is determined in accordance with the specification of the image former 105. Specifically, the first density is determined in accordance with the correction amount of the surface potential of the photoreceptor drums 121, the correction amount of the voltage value in a process of visualizing electrostatic latent images formed on the photoreceptor drums 121, the current value in a process of transferring the visualized toner image of each color onto the transfer belt 122, and the like. Alternatively, the controller 108 may determine the first density in accordance with the distribution of multiple pixel values included in an image based on the image data 111. Further, the controller 108 may determine the first density and the second density such that the difference between the first density and the second density becomes larger than a predetermined density difference. For example, it is assumed that the first density is the maximum density. In this case, when the density of the second color material is the maximum density in step S404, the determination unit 109 determines whether the density of the first color material is lower than the maximum density in step S405. When the densities of all the color components in the first color material are not the maximum densities, the determination unit 109 determines that the density of the first color material is lower than the maximum density.

For example, when the density of black (K) is 80%, the density of cyan (C) is 0%, the density of magenta (M) is 0%, and the density of yellow (Y) is 0% among the multiple color components in the first color material, it is determined that the density of the first color material is lower than the maximum density. Alternatively, for example, when the density of black (K) is 80%, the density of cyan (C) is 20%, the density of magenta (M) is 0%, and the density of yellow (Y) is 0% among the multiple color components used in the first color material used for the first pixel P1, it is determined that the density of the first color material is lower than the maximum density.

On the other hand, when the densities of all the color components of the first color material are the maximum densities, the determination unit 109 determines that the density of the first color material is the maximum density. For example, when the density of black (K) is 100%, the density of cyan (C) is 0%, the density of magenta (M) is 0%, and the density of yellow (Y) is 0% among the color components used in the first color material used for the first pixel P1, it is determined that the density of the first color material is the maximum density.

When the density of the first color material is equal to or higher than the first density in step S405, the controller 108 returns the processing to step S402. For example, it is assumed that the first density is the maximum density. In this case, when the density of the first color material is the maximum density in step S405, the controller 108 returns the processing to step S402. That is, the determination unit 109 selects a new first pixel P1 and continues the processing.

On the other hand, when the density of the first color material is lower than the first density in step S405, the correction unit 110 corrects the pixel value of the first pixel P1 in step S406. For example, it is assumed that the first density is the maximum density. In this case, when the density of the first color material is lower than the maximum density in step S405, the correction unit 110 corrects the pixel value of the first pixel P1 in step S406. The correction unit 110 corrects the density of the first color material by correcting the pixel value of the first pixel P1.

Specifically, the correction unit 110 reduces the pixel value of the first pixel P1. The correction unit 110 reduces the density of the first color material by reducing the pixel value of the first pixel P1.

In step S407, the correction unit 110 determines whether to end the process of correcting the pixel value. For example, when the determination unit 109 selects all the pixels indicated by the pixel value information indicated by the image data 111 in step S402 as the first pixels P1, the correction unit 110 determines to end the process of correcting the pixel value. Alternatively, in step S402, when the determination unit 109 selects all the pixels included in the first region R1 adjacent in the second direction D2 to the second region indicating a linear object along the first direction D1 as the first pixels P1, the correction unit 110 may determine to end the process of correcting the pixel value.

When the correction unit 110 does not determine to end the process of correcting the pixel value in step S407, the controller 108 returns the processing to step S402 and continues the processing. On the other hand, when the correction unit 110 determines to end the process of correcting the pixel value in step S407, the controller 108 ends the processing.

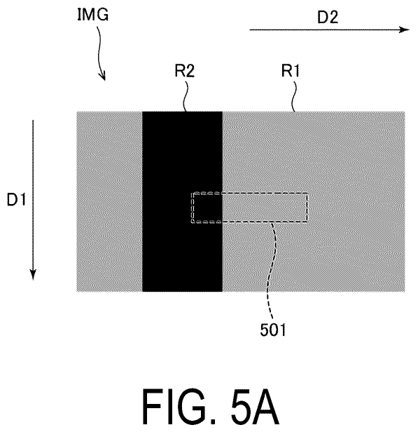

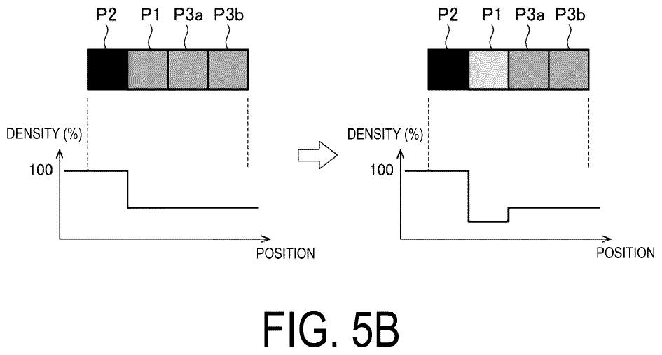

Correction of the pixel value of the first pixel P1 in the image forming device 100 according to the present embodiment will be described in detail with reference to FIGS. 5A to 5B.

FIG. 5A is a diagram illustrating an example of a region 501 including a linear object and a background of the linear object. In this example, a case where the first density and the second density are the maximum densities will be described as an example. Note that FIG. 5A illustrates an example of an image IMG including the region 501. The region 501 includes a part of the second region R2 indicating a linear object and a part of the first region R1 indicating a background region.

FIG. 5B is a diagram illustrating an example of the densities of a color materials used for pixels in the region 501 illustrated in FIG. 5A. In this example, a case where the first density and the second density are the maximum densities will be described as an example. The left side of FIG. 5B is a graph showing the densities of the color material before correction by the processing in step S406 illustrated in FIG. 4 for the second pixel P2, the first pixel P1, a pixel P3a, and a pixel P3b in the region 501. The first pixel P1, the pixel P3a, and the pixel P3b are parts of the first region R1. The second pixel P2 is a part of the second region R2.

The right side of FIG. 5B is a graph showing the pixel values after the correction by the processing in step S406 for the second pixel P2, the first pixel P1, the pixel P3a, and the pixel P3b. Color materials for the second pixel P2, the first pixel P1, the pixel P3a, and the pixel P3b are the same. The density of a second color material used for the second pixel P2 is the maximum density, and the densities of the color materials used for the first pixel P1, the pixel P3a, and the pixel P3b are lower than the maximum density. In this case, in step S406 illustrated in FIG. 4, the correction unit 110 reduces the density of a first color material used for the first pixel P1. As a result, the image forming device 100 according to the present embodiment can suppress a phenomenon in which characters and ruled lines on a colored background appear thicker than the characters and the ruled lines on a non-colored region.

### Second Embodiment

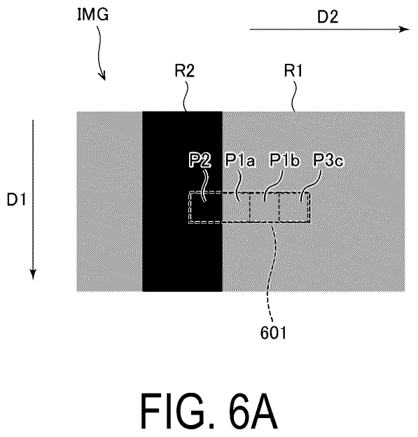

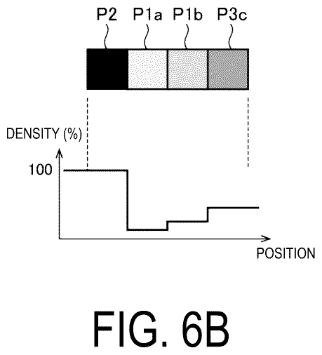

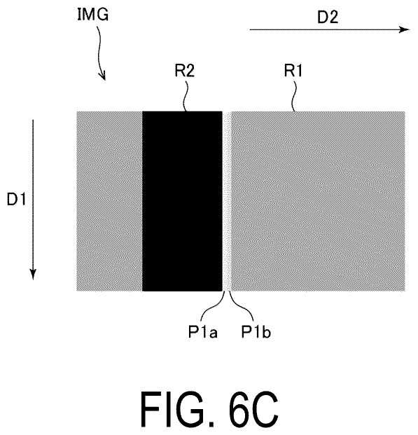

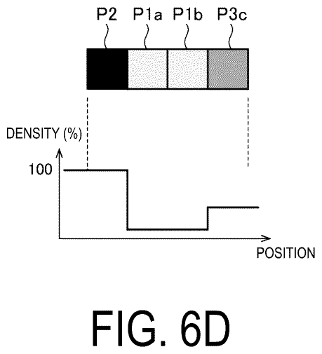

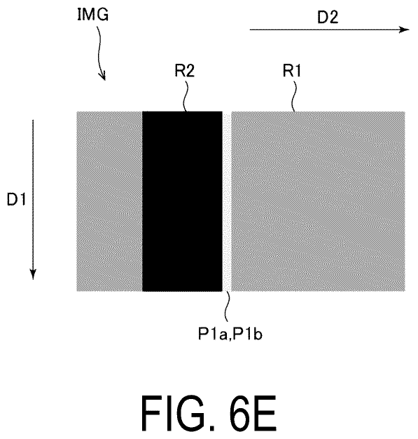

The second embodiment will be described with reference to FIGS. 6A to 6E. In the drawings, the same or equivalent elements are denoted by the same reference signs, and redundant descriptions will be omitted.

The determination unit 109 according to the present embodiment selects, as first pixels P1, pixels located within a predetermined range from the second pixel P2 among multiple pixels included in the first region R1 adjacent to the second region R2 including the second pixel P2. In this case, the correction unit 110 according to the present embodiment executes, as a correction process, a process of reducing the density of the first color material such that the first pixel P1 closer to the second pixel P2 has a lower density.

Correction of the pixel value of the first pixel P1 in the image forming device 100 according to the present embodiment will be described in detail with reference to FIGS, 6A to 6B.

FIG. 6A is a diagram illustrating an example of a region 601 including a linear object and a background of the linear object. In this example, a case where the first density and the second density are the maximum densities will be described as an example. The region 601 includes a part of the second region R2 indicating a linear object and a part of the first region R1 indicating a colored background. A first pixel P1a, a first pixel P1b, and a pixel P3c are parts of the first region R1. The second pixel P2 is a part of the second region R2. In FIG. 6A, the first pixels P1 correspond to pixels located within a range of two pixels from the second pixel P2 in the second direction D2 among multiple pixels included in the first region R1.

FIG. 6B is a graph showing an example of the densities of color materials after correction for pixels in the region 601 illustrated in FIG. 6A. In this example, a case where the first density and the second density are the maximum densities will be described as an example. Specifically, FIG. 6B illustrates an example of the densities of the color materials after the correction by the processing in step S406 for the second pixel P2, the first pixel P1a, the first pixel P1b, and the pixel P3c. FIG. 6C is a diagram illustrating an example of an image IMG after the correction illustrated in FIG. 6B.

Color materials for the second pixel P2, the first pixel P1a, the first pixel P1b, and the pixel P3c are the same. Further, the density of a second color material used for the second pixel P2 is the maximum density, and the densities of the color materials used for the first pixel P1a, the first pixel P1b, and the pixel P3c are lower than the maximum density. Furthermore, the first pixel P1a is closer to the second pixel P2 than the first pixel P1b. Thus, in step S406 illustrated in FIG. 4, the correction unit 110 reduces the density of the color material used for the first pixel P1a to be lower than the density of the color material used for the first pixel P1b. Accordingly, the density of the boundary between the colored background and the linear object can be reduced.

As a comparative example of the image forming device 100 according to the present embodiment, a case in which the densities of the color materials used for the first pixel P1a and the first pixel P1b are made uniform will be described with reference to FIGS. 6D to 6E.

FIG. 6D is a graph showing an example of the densities of the color materials after the correction for the pixels in the region 601 illustrated in FIG. 6A. Specifically, FIG. 6D illustrates a comparative example of the densities of the color materials after the correction by the processing in step S406 illustrated in FIG. 4 for the first pixel P1a, the first pixel P1b, and the pixel P3c. FIG. 6E is a diagram illustrating an example of an image IMG after the correction illustrated in FIG. 6D.

As illustrated in FIG. 6D, correction by the correction unit 110 to uniform the densities of the color materials used for the first pixel P1a and the first pixel P1b results in overcorrection, causing a void at the boundary between the second region R2 and the first region R1 as illustrated in FIG. 6E. On the other hand, as illustrated in FIG. 6B, the correction unit 110 reduces the density of the first color material used for the first pixel P1a and the first pixel P1b such that the density becomes lower as the distance from the second pixel P2 is shorter. Thus, as illustrated in FIG. 6C, the image forming device 100 according to the present embodiment can suppress the occurrence of a void at the boundary between the second region R2 and the first region R1.

As described above, the image forming device 100 according to the present embodiment can reduce the possibility of occurrence of a void having a clear edge adjacent to a linear object due to overcorrection.

### Third Embodiment

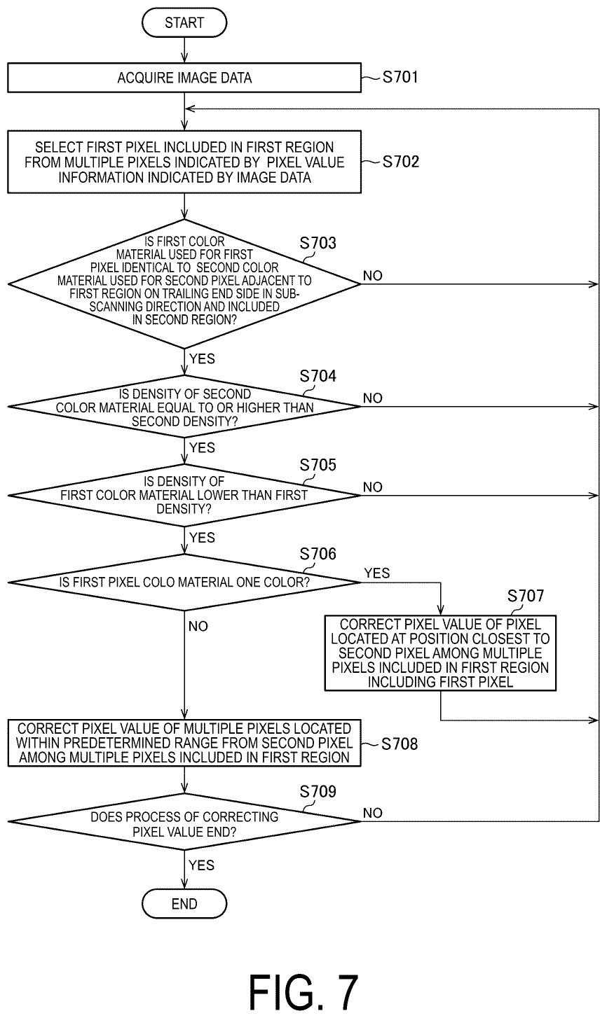

The third embodiment will be described with reference to FIGS. 7 to 9. In the drawings, the same or equivalent elements are denoted by the same reference signs, and redundant descriptions will be omitted.

When the first color material is one color, the correction unit 110 according to the present embodiment executes, as a correction process, a process of reducing the density of the first color material used for the first pixel P1 closest to the second pixel P2 included in the second region R2 adjacent to the first region R1 including the first pixels P1 on the trailing end side in the second direction D2.

When the first color material is not one color, the correction unit 110 according to the present embodiment executes, as a correction process, a process of reducing the density of the first color material such that the density becomes lower as the distance from the second pixel P2 included in the second region R2 adjacent to the first region R1 including the first pixels P1 on the trailing end side in the second direction D2 is shorter.

FIG. 7 is a flowchart illustrating an example of an operation of the image forming device 100 according to the present embodiment. The processing from step S701 to step S705 is the same as the processing from step S401 to step S405 illustrated in FIG. 4, and thus detailed description thereof will be omitted.

When the determination unit 109 determines in step S705 that the density of the first color material used for the first pixel P1 selected in step S702 is lower than the first density, the determination unit 109 determines in step S706 whether the first color material is one color. For example, it is assumed that the first density is the maximum density. In this case, when the determination unit 109 determines in step S705 that the density of the first color material used for the first pixel PI selected in step S702 is lower than the maximum density, the determination unit 109 determines in step S706 whether the first color material is one color. Specifically, the determination unit 109 determines whether the color component of the first color material is one color. When the color component used in the first color material is one color, the determination unit 109 determines that the first color material is one color. On the other hand, when two or more color components are used in the first color material, the determination unit 109 determines that the first color material is not one color.

When the first color material is one color in step S706, in step S707, the correction unit 110 corrects the pixel value of the pixel located at a position closest to the second pixel P2 among multiple pixels included in the first region R1 including the first pixel P1. Specifically, the correction unit 110 reduces the density of the first color material used for the pixel located at a position closest to the second pixel P2 among the multiple pixels included in the first region R1 including the first pixel P1.

On the other hand, when the first color material is not one color in step S706, in step S708, the correction unit 110 corrects the first color material used for multiple pixels located within a predetermined range from the second pixel P2 among multiple pixels included in the first region R1.

In step S709, the correction unit 110 determines whether to end the process of correcting the pixel value. For example, when the determination unit 109 selects all the pixels indicated by the pixel value information indicated by the image data 111 in step S702 as the first pixels P1, the correction unit 110 determines to end the process of correcting the pixel value. Alternatively, in step S702, when the determination unit 109 selects all the pixels included in the first region R1 adjacent in the second direction D2 to the second region indicating a linear object along the first direction D1 as the first pixels P1, the correction unit 110 may determine to end the process of correcting the pixel value.

When the correction unit 110 does not determine to end the process of correcting the pixel value in step S709, the controller 108 returns the processing to step S702 and continues the processing. On the other hand, when the correction unit 110 determines to end the process of correcting the pixel value in step S709, the controller 108 ends the process of correcting the pixel value.

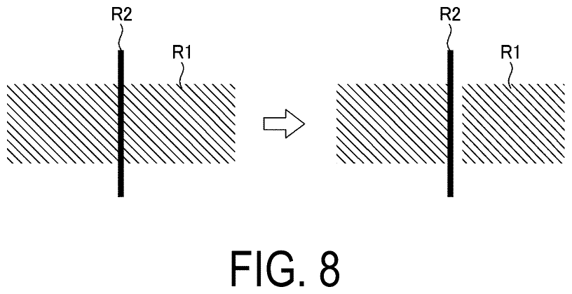

FIG. 8 is a diagram illustrating an example of a case where the color material used for the first region R1 adjacent to the second region R2 is one color and the density of the color material is reduced for multiple pixels included in the first region R1. The second region R2 indicates a linear object. The first region R1 indicates a colored background of the linear object indicated by the second region R2.

As illustrated in FIG. 8, when the first color material is the same as the second color material used in the second region R2 and the first color material is one color, reduction of the density of the first color material used for multiple first pixels located within a range of two or more pixels from the second pixel P2 by the correction unit 110 results in overcorrection, causing a void at the boundary between the first region R1 and the second region R2. As a result, the boundary between the first region R1 and the second region R2 is excessively perceived.

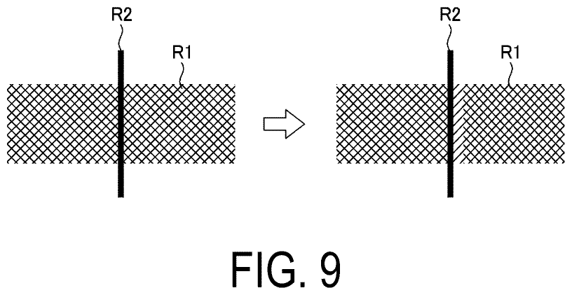

FIG. 9 is a diagram illustrating an example of a case where the first color material used for the first region R1 is not one color and the density of the color material is reduced for multiple pixels included in the first region R1. The second region R2 indicates a linear object. The first region R1 indicates a colored background of the linear object indicated by the second region R2.

As illustrated in FIG. 9, in a case where the first color material is the same as the second color material used in the second region R2 and the first color material is not one color, even when the correction unit 110 reduces the density of the first color material used for multiple first pixels located within a range of two or more pixels from the second pixel P2 included in the second region R2, it is possible to prevent the boundary between the first region R1 and the second region R2 from being excessively perceived.

As described above, in a case of printing a linear object on a colored background, the image forming device 100 according to the present embodiment changes the range of a pixel region in which density reduction is performed in accordance with whether the color of the background is a single color or a mixed color. Accordingly, the image forming device 100 according to the present embodiment can effectively reduce the density of the boundary between the colored background and the linear object while suppressing a void due to the overcorrection of the boundary between the colored background and the linear object.

### Fourth Embodiment

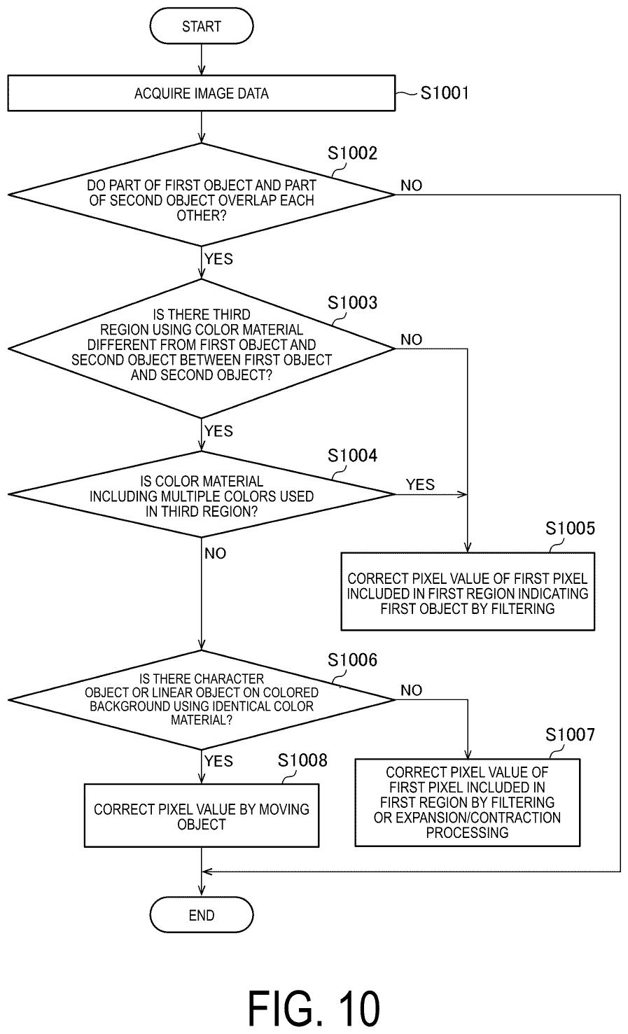

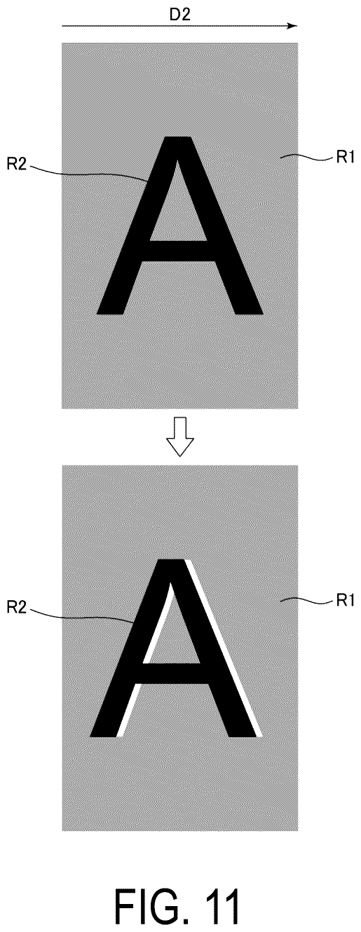

The fourth embodiment will be described with reference to FIGS. 10 to 11.

The correction unit 110 according to the present embodiment executes, as a correction process, a process of reducing the density of the first color material by filtering.

When a part of a first object indicated by the first region R1 and a part of a second object, which is indicated by the second region R2 and uses a color material whose density is equal to or higher than the second density, overlap each other, or when the color material used in a region in contact with the boundary between the first region R and the second region R2 is one color, the correction unit 110 according to the present embodiment executes, as a correction process, a process of reducing the density of a first color material used for the first pixel P1 included in the first region R1 by filtering. For example, it is assumed that the first density and the second density are the maximum density. In this case, when a part of the first object indicated by the first region R1 and a part of the second object, which is indicated by the second region R2 and uses a color material whose density is equal to or higher than the maximum density, overlap each other, or when the color material used in a region in contact with the boundary between the first region R1 and the second region R2 is one color, the correction unit 110 according to the present embodiment executes, as a correction process, a process of reducing the density of the first color material used for the first pixel P1 included in the first region R1 by filtering.

Alternatively, the correction unit 110 according to the present embodiment may execute, as a correction process, a process of reducing the density of the color material used for the pixel on the most leading end side in the second direction D2 among multiple pixels included in the second region R2 including the second pixel P2.

Alternatively, the correction unit 110 according to the present embodiment may execute, as a correction process, a process of expanding/contracting the second region R2 including the second pixel P2, and a process of reducing the density of the color material used for the pixel on the most leading end side in the second direction D2 with respect to the second pixel P2 among multiple pixels included in the expanded/contracted second region R2.

When the color material used in a region in contact with the boundary between the first region R1 and the second region R2 is not one color and the density of the color material used in the region in contact with the boundary between the first region R1 and the second region R2 is equal to or higher than the second density, the correction unit 110 according to the present embodiment executes, as a correction process, a process of expanding/contracting the second region R2 to reduce the density of the color material used for a pixel on the most leading end side in the second direction D2 among multiple pixels included in the second region R2, thereby blanking out the pixel. For example, it is assumed that the first density and the second density are the maximum density. In this case, when the color material used in the region in contact with the boundary between the first region R1 and the second region R2 is not one color and the density of the color material used in the region in contact with the boundary between the first region R1 and the second region R2 is the maximum density, the correction unit 110 according to the present embodiment executes, as a correction process, a process of expanding/contracting the second region R2 to reduce the density of the color material used for a pixel on the most leading end side in the second direction D2 among multiple pixels included in the second region R2, thereby blanking out the pixel.

In addition, the correction unit 110 according to the present embodiment may execute, as a correction process, a process of reducing the density of the color material used in the second region R2 including the second pixel P2 and moving the second region R2 in which the second color material is used toward the trailing end side in the second direction D2 by a predetermined number of pixels to superimpose the second region R2. That is, the correction unit 110 according to the present embodiment may execute, as a correction process, a process of reducing the density of the color material used in the second region R2 including the second pixel P2, replicating the second region R2 before the reduction of the density of the color material, and moving the replicated second region R2 toward the trailing end side in the second direction D2 by a predetermined number of pixels to superimpose the replicated second region R2.

When the color material used in a region in contact with the boundary between the first region R1 and the second region R2 is not one color and the density of the color material used in the region in contact with the boundary between the first region R1 and the second region R2 is equal to or higher than the second density, the correction unit 110 according to the present embodiment executes, as a correction process, a process of reducing the density of the color material used in the second region R2 including the second pixel P2, replicating the second region R2 before the reduction of the density of the color material, and moving the replicated second region R2 toward the trailing end side in the second direction D2 by a predetermined number of pixels to superimpose the replicated second region R2. For example, it is assumed that the first density and the second density are the maximum density. In this case, when the color material used in the region in contact with the boundary between the first region R1 and the second region R2 is not one color and the density of the color material used in the region in contact with the boundary between the first region R1 and the second region R2 is the maximum density, the correction unit 110 according to the present embodiment executes, as a correction process, a process of reducing the density of the color material used in the second region R2 including the second pixel P2, replicating the second region R2 before the reduction of the density of the color material, and moving the replicated second region R2 toward the trailing end side in the second direction D2 by a predetermined number of pixels to superimpose the replicated second region R2. Accordingly, the correction unit 110 according to the present embodiment generates a low-density region having a predetermined number of pixels on the leading end side in the second direction D2 in the second region R2.

FIG. 10 is a flowchart illustrating an example of an operation of the image forming device 100 according to the present embodiment.

In step S1001, the image acquisition unit 104 acquires the image data 111.

In step S1002, the determination unit 109 determines whether a part of a first object indicated by the first region R1 and a part of a second object which is indicated by the second region R2 and uses a color material whose density is equal to or higher than the second density overlap each other in the image based on the acquired image data 111. For example, it is assumed that the first density and the second density are the maximum density. In this case, the determination unit 109 determines in step S1002 whether a part of the first object indicated by the first region R1 and a part of the second object which is indicated by the second region R2 and uses a color material whose density is the maximum density overlap each other in the image based on the acquired image data 111. The second object indicates a character object or a linear object.

When a part of the first object and a part of the second object do not overlap in step S1002, the controller 108 ends the processing. On the other hand, when a part of the first object and a part of the second object overlap each other in step S1002, it is determined in step S1003 whether there is a third region R3 between the first object and the second object, the third region R3 being a boundary region in which a color material different from those of the first object and the second object is used. That is, the determination unit 109 determines whether the third region R3 is present in contact with the boundary between the first region R1 and the second region R2.

When the third region R3 is not present between the first object and the second object in step S1003, the controller 108 causes the processing to proceed to step S1005.

On the other hand, when the third region R3 is present between the first object and the second object in step S1003, the controller 108 causes the processing to proceed to step S1004.

In step S1004, the determination unit 109 determines whether a color material including multiple color components is used in the third region R3. In step S1004, when the color material including multiple color components is not used in the third region R3, the controller 108 causes the processing to proceed to step S1005. On the other hand, when the color material used for the third region R3 is not one color in step S1004, the controller 108 causes the processing to proceed to step S1006.

In step S1005, the correction unit 110 corrects the density of the first color material used for the first pixel P1 included in the first region R1 indicating the first object by filtering. As a result, the correction unit 110 can suppress a phenomenon in which an object on a colored background appears thicker than the object on a non-colored region while sharpening and smoothing the object on the colored background by the processing in step S1005.

In step S1006, the determination unit 109 determines whether there is a character object or a linear object on a background in which the same color material is used.

When there is no character object or no linear object on a background in which the same color material is used in step S1006, in step S1007, the correction unit 110 reduces the density of the first color material used for the first pixel P1 included in the first region R1 indicating the first object by filtering. Alternatively, when there is no character object or no linear object on the background in which the same color material is used in step S1006, in step S1007, the correction unit 110 executes a process of expanding/contracting the second region R2 to reduce the density of the color material used for a pixel on the most leading end side in the second direction D2 with respect to the second pixel P2 among multiple pixels included in the expanded/contracted second region R2, thereby blanking out the pixel. Accordingly, the correction unit 110 can adjust the thickness of a character object or a linear object indicated by the second region R2. As a result, the correction unit 110 can suppress a phenomenon in which a character object or a linear object on a colored background appears thicker than an object on a non-colored region while adjusting the thickness of the character object or the linear object on the colored background by the processing in step S1007.

On the other hand, when there is a character object or a linear object on a background in which the same color material is used in step S1006, in step S1008, the correction unit 110 reduces the density of the color material used in the second region R2 including the second pixel P2, and moves the second region R2 in which the second color material is used to the trailing end side in the second direction D2 by a predetermined number of pixels to superimpose the second region R2. Accordingly, the correction unit 110 generates a low-density region having the predetermined number of pixels on the leading end side in the second direction D2 in the second region R2. Since the correction unit 110 arranges an object in a shifted manner without performing filtering or expansion/contraction process for each pixel by the processing in step S1008, it is possible to save the memory and the processing time required for the filtering or expansion/contraction process.

In printing image data with multiple pages, when duplex printing is performed or when intensive printing in which multiple pages are consolidated by being laid out in one page is performed, the printing direction with respect to the orientation (left-right and up-down directions) of the image data may change for each page. When the printing direction with respect to the orientation of the image data changes for each page, the correction unit 110 may rotate the image such that the printing direction becomes a predetermined constant direction, perform the filtering or expansion/contraction process, and then rotate the image again in the reverse direction to return to the original orientation of the image data, or may switch the parameter of the filtering or expansion/contraction process between multiple parameters with rotation by 90 degrees, 180 degrees, and 270 degrees in accordance with the printing direction.

FIG. 11 is a diagram illustrating an example of the processing of step S1008 illustrated in FIG. 10.

In the first region R1, the character object “A” indicated by the second region R2 is indicated on the background region indicated by the first region R1. The color material used in the first region R1 and the color material used in the second region R2 are the same. In this case, the correction unit 110 moves the character object indicated by the second region R2 to the trailing end side in the second direction D2 by a predetermined number of pixels to superimpose the character object. As a result, as illustrated in the lower part of FIG. 11, it is possible to generate a low-density region having the predetermined number of pixels on the leading end side in the second direction D2 in the second region R2. Accordingly, the image forming device 100 according to the present embodiment can suppress a phenomenon in which a character object or a linear object on a colored background appears thicker than an object on a non-colored region.

### Fifth Embodiment

The fifth embodiment will be described.

In a case where non-colored regions and colored regions are alternately arranged in the first direction D1, when a linear object intersecting a non-colored region and a colored region is arranged and the color material used in the colored region is the same as the color material used in the region indicating the linear object, a phenomenon in which the linear object on the colored background appears thicker than the linear object on the non-colored region is likely to be perceived. Note that the non-colored region is a region where the image former 105 does not cause the color material to adhere to the sheet 201.

When the non-colored region and the first region R1 constituted by the first pixel P1 are alternately arranged in the first direction D1, the correction unit 110 according to the present embodiment executes a process of reducing the density of the first color material as a correction process. Accordingly, when a phenomenon in which a linear object on a colored background appears thicker than an object on a non-colored region is likely to be perceived, the image forming device 100 according to the present embodiment can reduce the density of the color material, thereby suppressing an adverse effect caused by the reduction of the density of the color material.

### Sixth Embodiment

The sixth embodiment will be described.

When the density of the second color material used for the second pixels P2 of the number of pixels located within a predetermined range on the trailing end side in the second direction D2 with respect to the first pixel P1 is equal to or higher than the second density, the correction unit 110 according to the present embodiment reduces the density of the first color material used for the first pixel P1. For example, it is assumed that the first density and the second density are the maximum density. In this case, when the density of the second color material used for the second pixels P2 of the number of pixels located within a predetermined range on the trailing end side in the second direction D2 with respect to the first pixel P1 is the maximum density, the correction unit 110 according to the present embodiment reduces the density of the first color material used for the first pixel P1.

For example, when a linear object is arranged on a colored background and the linear object is sufficiently thin, a phenomenon in which the linear object on the colored background appears thicker than the linear object on a non-colored region is less likely to occur. Here, the sufficient thinness varies depending on the image forming device 100. Thus, when the linear object is sufficiently thin, the correction unit 110 does not correct the density of the color material used for the pixel of the colored background adjacent to the linear object. Specifically, in a case where the determination unit 109 determines that the first color material and the second color material are the same, the first color material has a density lower than the first density, and the second color material has a density equal to or higher than the second density, the correction unit 110 according to the present embodiment executes a correction process when multiple second pixels P2 using the second color material are continuous from the first pixels P1 to the trailing end side in the second direction D2 by the number of the first pixels or more. For example, it is assumed that the first density and the second density are the maximum density. In this case, in a case where the determination unit 109 determines that the first color material and the second color material are the same, the first color material does not has the maximum density, and the second color material has the maximum density, the correction unit 110 according to the present embodiment executes a correction process when multiple second pixels P2 using the second color material are continuous from the first pixels P1 to the trailing end side in the second direction D2 by the number of the first pixels or more. Accordingly, the image forming device 100 according to the present embodiment can prevent an adverse effect caused by reducing the density of the color material in a thin line region.

In addition, for example, when a linear object is arranged on a colored background and the linear object is sufficiently thick, a phenomenon in which the linear object on the colored background appears thicker than the linear object on a non-colored region is less likely to be perceived. Thus, when the linear object is sufficiently thick, the correction unit 110 does not correct the density of the color material used for the pixel of the colored background adjacent to the linear object. Specifically, in a case where the determination unit 109 determines that the first color material and the second color material are the same, the first color material has a density lower than the first density, and the second color material has a density equal to or higher than the second density, the correction unit 110 according to the present embodiment executes a correction process when multiple second pixels P2 using the second color material are continuous from the first pixels P1 to the trailing end side in the second direction D2 by the number of the second pixels or less, which is larger than the number of the first pixels. For example, in the case of 600 dpi, when the number of the second pixels is 22 pixels, the correction unit 110 executes the correction process for a region having a width of equal to or less than the 1 mm. For example, it is assumed that the first density and the second density are the maximum density. In this case, in a case where the determination unit 109 determines that the first color material and the second color material are the same, the first color material does not has the maximum density, and the second color material has the maximum density, the correction unit 110 according to the present embodiment executes a correction process when multiple second pixels P2 using the second color material are continuous from the first pixels P1 to the trailing end side in the second direction D2 by the number of the second pixels or less, which is larger than the number of the first pixels. Accordingly, the image forming device 100 according to the present embodiment can prevent an adverse effect caused by reducing the density of the color material in a thick line region.

### Seventh Embodiment

The seventh embodiment will be described.

In the image forming device 100 according to the present embodiment, when it is determined that the first color material and the second color material are the same, a first mask region adjacent to the first pixel P1 and located on the leading end side in the second direction D2 is composed of pixels having a density lower than the first density, and a second mask region adjacent to the first pixel P1 and located on the trailing end side in the second direction D2 is composed of pixels having a density higher than the second density, the correction unit 110 according to the present embodiment executes a correction process on the first pixel P1.

For example, when the mean value of the pixel values of multiple pixels included in the first mask region is lower than the first density and the mean value of the pixel values of multiple pixels included in the second mask region is higher than the second density, the correction unit 110 executes the correction process on the first pixel P1. In addition, for example, when the most frequent value of the pixel values of the multiple pixels included in the first mask region is lower than the first density and the most frequent value of the pixel values of the multiple pixels included in the second mask region is higher than the second density, the correction unit 110 may execute the correction process on the first pixel P1. Accordingly, even when the pixel values of the pixels around the first pixel P1 are not uniform, the correction unit 110 can execute the correction process on the first pixel P1. As a result, even when the color of a colored background is not uniform, it is possible to suppress a phenomenon in which characters and ruled lines on a colored background appear thicker than characters and ruled lines on a non-colored region.

In addition, the correction unit 110 according to the present embodiment may scan a mask including the first mask region and the second mask region in the second direction D2 to determine whether to execute the correction process on the first pixel P1. Specifically, when it is determined that the first color material and the second color material are the same, the mask including the first mask region and the second mask region is scanned in the second direction D2, and a region surrounding the first pixel P1 matches the mask, the correction unit 110 according to the present embodiment executes the correction process.

As described above, the image forming device 100 according to the present embodiment can suppress a phenomenon in which characters and ruled lines on a colored background appear thicker than the characters and the ruled lines on a non-colored region even when the pixels constituting the characters and the pixels constituting the ruled lines on the colored background are not arranged in the first direction D1.

The eighth embodiment will be described.

The correction unit 110 according to the present embodiment executes, as a correction process, a process of reducing the density of the first color material to whiten the first pixel P1. Thus, it is not necessary for the correction unit 110 to determine the density of the first color material after the correction process in accordance with the density of the first color material before the correction process, and the processing load can be reduced.

When the correction unit 110 sets the density of the first pixel P1 to white, a blank is generated adjacent to the second pixel P2. However, when the image former 105 causes the second color material to adhere to the sheet 201 for the second pixel P2, the thickness of the blank becomes thin due to a physical dot gain phenomenon. Further, light diffused and scattered not only on the surface of the sheet 201 but also inside the sheet 201 forms a white portion of the sheet 201. However, the position of the first pixel P1 set to white become less likely to be perceived as a white point or white on the sheet 201 due to an optical dot gain phenomenon in which the optical density of a peripheral portion of a region to which the color material adhered is lowered by at least one of light obliquely incident on the sheet 201 being blocked by the region to which the color material adhered or the light obliquely incident on the sheet 201 spectrally partially transmitting the region to which the color material adhered and, in addition, a blank region is provided, whereby the influence from the second pixel P2 having the predetermined second density can be eliminated. Specifically, by providing the blank region, it is possible to significantly reduce the influence of potential diffusion on the photoreceptors from the second pixel P2 at the time of image formation and the electrostatic influence and the electrical influence at the time of transfer to the photoreceptors and the transfer belt 122. As described above, the image forming device 100 according to the present embodiment can suppress the phenomenon in which characters and ruled lines on a colored background appear thicker than the characters and the ruled lines on a non-colored region while reducing the processing load.

Each processing executed in the above-described embodiments is not limited to the processing mode described in each embodiment. The above-described functional blocks may be implemented by using either a logic circuit (hardware) formed in an integrated circuit or the like or software using a CPU.

The disclosure is not limited to the above-described embodiments, and may be replaced with a configuration that is substantially the same as the configuration described in the above-described embodiments, or a configuration that achieves the same operation and effect, or a configuration that can achieve the same object as the configuration described in the above-described embodiments. Embodiments obtained by appropriately combining technical means disclosed in different embodiments are also included in the technical scope of the disclosure. Furthermore, new technical features can be formed by combining the technical means disclosed in the respective embodiments.

What is claimed is:

1. An image forming device comprising:
a controller;
an image former that causes a color material to adhere to a sheet for each of multiple pixels arranged in a first direction; and
a sheet feeder that feeds the sheet in a second direction,
the controller
determining whether a first color material used for a first pixel out of the multiple pixels is identical to a second color material used for a second pixel adjacent to the first pixel on a trailing end side in the second direction with respect to the first pixel, and
executing a correction process of correcting a density of the first color material when it is determined that the first color material is identical to the second color material, the density of the first color material is lower than a first density, and a density of the second color material is equal to or higher than a second density that is equal to or higher than the first density.

2. The image forming device according to claim 1, wherein the controller executes the correction process when it is determined that the first color material is identical to the second color material, the density of the first color material is not a maximum density, and the density of the second color material is the maximum density.

3. The image forming device according to claim 1, wherein a difference between the first density and the second density is larger than a predetermined density difference.

4. The image forming device according to claim 1, wherein when multiple second pixels are arranged in the first direction, multiple first pixels are arranged along the multiple second pixels.

5. The image forming device according to claim 1, wherein the correction process reduces the density of the first color material.

6. The image forming device according to claim 1, wherein
the first pixel includes pixels located within a predetermined range from the second pixel among multiple pixels included in a first region adjacent in the second direction to a second region including the second pixel, and
the correction process reduces the density of the first color material such that the density become lower in the first pixel closer to the second pixel.

7. The image forming device according to claim 1, wherein
when the first color material is one color, the correction process reduces the density of the first color material used for the first pixel closest to the second pixel included in a second region adjacent on a trailing end side in the second direction to a first region including the first pixel, and
when the first color material is not one color, the correction process reduces the density of the first color material such that the density becomes lower in the first pixel closer to the second pixel included in the second region adjacent on a trailing end side in the second direction to the first region including the first pixel.

8. The image forming device according to claim 1, wherein the correction process reduces the density of the first color material by filtering.

9. The image forming device according to claim 1, wherein the correction process executes a process of expanding/contracting a second region including the second pixel and reduces a density of a color material used for a pixel on a most leading end side in the second direction with respect to the second pixel among multiple pixels included in the second region that is expanded/contracted.

10. The image forming device according to claim 1, wherein the correction process reduces a density of a color material used in a second region including the second pixel and moves the second region in which the second color material is used toward a trailing end side in the second direction by a predetermined number of pixels to superimpose the second region.

11. Image forming device according to claim 1, wherein when a non-colored region and a first region composed of the first pixel are alternately arranged in the first direction, the correction process reduces the density of the first color material used for the first pixel constituting the first region.

12. The image forming device according to claim 1, wherein in a case where it is determined that the first color material is identical to the second color material, the density of the first material is lower than the first density, and the density of the second color material is equal to or higher than the second density, the controller executes the correction process when multiple second pixels are continuous from the first pixel on a trailing end side in the second direction by a first pixel count or more.

13. The image forming device according to claim 12, wherein in a case where it is determined that the first color material is identical to the second color material, the density of the first color material is lower than the first density, and the density of the second color material is equal to or higher than the second density, the controller executes the correction process when multiple second pixels are continuous from the first pixel on a trailing end side in the second direction by a second pixel count or less, the second pixel count being larger than the first pixel count.

14. The image forming device according to claim 1, wherein the controller executes the correction process when it is determined that the first color material is identical to the second color material, a first mask region adjacent to the first pixel and located on a leading end side in the second direction is composed of pixels having a density lower than the first density, and a second mask region adjacent to the first pixel and located on a trailing end side in the second direction is composed of pixels having a density higher than the second density.

15. The image forming device according to claim 14, wherein the controller executes the correction process when it is determined that the first color material is identical to the second color material, a mask including the first mask region and the second mask region is scanned in the second direction, and a region surrounding the first pixel matches the mask.

16. The image forming device according to claim 1, wherein the correction process reduces the density of the first color material such that the first pixel is whitened.

17. An image forming method executed by one or more processors, the image forming method comprising:
determining whether a first color material used for a first pixel out of multiple pixels arranged in a first direction is identical to a second color material used for a second pixel on a trailing end side in a second direction with respect to the first pixel;
executing a correction process of correcting a density of the first color material when it is determined that the first color material is identical to the second color material, the density of the first color material is lower than a first density, and a density of the second color material is equal to or higher than a second density that is equal to or higher than the first density;
causing a color material to adhere to a sheet for each of the multiple pixels arranged in the first direction; and
feeding the sheet to the second direction.

18. A non-transitory computer-readable recording medium storing a program executed by a computer, the computer controlling an image forming device including an image former that causes a color material to adhere to a sheet for each of multiple pixels arranged in a first direction and a sheet feeder that feeds the sheet in a second direction, the program causing the computer to:
determine whether a first color material used for a first pixel out of the multiple pixels is identical to a second color material used for a second pixel on a trailing end side in a second direction with respect to the first pixel; and
execute a correction process of correcting a density of the first color material when it is determined that the first color material is identical to the second color material, the density of the first color material is lower than a first density, and a density of the second color material is equal to or higher than a second density that is equal to or higher than the first density.
